(19) United States
(12) Patent Application Publication
(10) Pub. No.: US 2014/0125706 A1
(43) Pub. Date: May 8, 2014

(54) GEOMORPHING DEVICE

(71) Applicants: Satoshi Sakurai, Tokyo (JP); Shoichiro Kuboyama, Tokyo (JP)

(72) Inventors: Satoshi Sakurai, Tokyo (JP); Shoichiro Kuboyama, Tokyo (JP)

(73) Assignee: Mitsubishi Electric Corporation, Tokyo (JP)

(21) Appl. No.: 14/129,642

(22) PCT Filed: Sep. 12, 2011
(86) PCT No.: PCT/JP2011/005112

§ 371 Date: Dec. 27, 2013

(51) Int. Cl. G06T 5/30

(52) U.S. Cl. CPC G06T 5/30
USPC 345/646

(57) ABSTRACT

In the present invention, an input assembly unit (1) receives vertex information used before and after geomorphing and index information as input, and uses the index information to output vertex information used before and after the geomorphing of each polygon. A polygon processing unit (3) interpolates vertex information that has been processed at a vertex processing unit (2) in accordance with the time in order to perform output for each polygon. A rasterizing unit (4) detects pixels included in each polygon output by the polygon processing unit (3) within the output image in order to output pixel information in which the vertex information for the polygon has been interpolated in accordance with the position of each pixel. A pixel processing unit (5) determines the color of each pixel of the corresponding output image using the pixel information.

### FIELD OF THE INVENTION

The present invention relates to a geomorphing device that smoothly replaces a polygon model with a different polygon model by gradually changing each vertex information of the polygon model.

### BACKGROUND OF THE INVENTION

In computer graphics, a polygon model is widely used as a method of expressing a two-dimensional or three-dimensional shape. In a polygon model, a triangle having three vertices is mainly defined as a unit shape, and a shape is expressed by a combination of triangles. Because each polygon consists of pieces of information including the positions of the three vertices and normals, in a case in which polygons are adjacent to each other, some of the polygons have the same vertex information and a redundancy occurs in the pieces of information about the plurality of polygons. To solve this problem, a technique of expressing pieces of polygon information in a polygon model by using both a set of pieces of vertex information each of which is not the same as any other vertex information within the polygon model, and three indexes respectively showing each of the pieces of vertex information, thereby reducing the data amount, is implemented typically (for example, refer to patent references 1, 2, and 3). FIG. 1 is a diagram showing a comparison between the amount of information in the case in which indexes are used and a case in which no indexes are used. In the figure, (a) is an explanatory drawing showing a relationship between vertices and polygons, (b) is a drawing showing an expression not using any index, and (c) is a drawing showing an expression using indexes. In this case, each vertex information is expressed by (position (12 bytes)+texture coordinates (8 bytes)+normal (12 bytes)+ . . . )≈40 bytes, and each index is expressed by an integer (2 bytes). Therefore, as shown in (a), the amount of vertex information in the case in which no indexes are used is 360 bytes while the amount of vertex information in the case in which indexes are used is 200+18=218 bytes.

On the other hand, geomorphing of smoothly replacing a polygon model with a different polygon model by gradually changing each vertex information of the polygon model is used typically (for example, refer to patent reference 4). The geomorphing is implemented by preparing the positions of each vertex before and after geomorphing in advance, and then displaying the different polygon model by repeatedly calculating vertex information which is linear-interpolated between the positions of each vertex. An example of a model which is subjected to the geomorphing at a time t ranging from 0 to 1 is shown in FIG. 2. In the figure, (a) shows a model state at the time t=0.0, (b) shows a model state at the time t=0.5, and (c) shows a model state at the time t=1.0.

Generally, a CPU or the like constructs a model during geomorphing by interpolating pieces of vertex information one by one, and therefore the amount of computation increases very much when the model has a large number of vertices. Therefore, a method of providing pieces of vertex information pair before and after geomorphing for a drawing device, such as a GPU (Graphics Processing Unit), and adding a process of performing interpolation between each pair of vertex information during a process of drawing the model to parallelize the interpolation process and perform the interpolation process at a high speed is proposed (for example, refer to nonpatent reference 1). Because according to this method programmable processes (a process for each vertex, a process for each polygon, and a process for each pixel) in a polygon drawing flow in a typical GPU shown in FIG. 3 can be implemented in a form in which they are programed, low-cost high-speed geomorphing is implemented. FIG. 4 shows information which is used when implementing the geomorphing as shown in FIG. 2 by using the method shown in nonpatent reference 1.

### RELATED ART DOCUMENT

### Patent Reference

Patent reference 1: Japanese Unexamined Patent Application Publication No. 2000-285255
Patent reference 2: Japanese Unexamined Patent Application Publication No. H06-162171
Patent reference 3: Japanese Unexamined Patent Application Publication No. 2004-102763
Patent reference 4: Japanese Unexamined Patent Application Publication No. 2001-076177

### Nonpatent Reference

[Nonpatent reference 1] Sander, P. V., Mitchell, J. L., “Progressive buffers: view-dependent geometry and texture LOD rendering,” Proc. of SIGGRAPH 06.

### SUMMARY OF THE INVENTION

### Problems to be Solved by the Invention

However, data is localized for parallel processing in the process which is performed on each vertex by a typical GPU, and therefore information about any other vertex cannot be referred to. A problem is therefore that it is necessary to prepare vertex information having two pieces of information about two vertices in advance, and it is therefore necessary to provide twice the typical amount of information. Particularly when a model after geomorphing is generated by reducing the number of polygons in a model before geomorphing to simplify this model before geomorphing, many pieces of vertex information are held redundantly.

A further problem is that when geomorphing a model in a plurality of stages, i.e., when further geomorphing a model after geomorphing to another model, it is necessary to prepare, in advance, pieces of vertex information each having information before and after geomorphing for each stage of geomorphing.

The present invention is made in order to solve the above-mentioned problems, and it is therefore an object of the present invention to provide a geomorphing device that can implement high-speed and memory-efficient geomorphing at a low cost.

### Means for Solving the Problem

In accordance with the present invention, there is provided a geomorphing device including: an input assembler that receives, as an input, vertex information in which pieces of information showing vertices used before and after geomorphing are recorded without redundancy and pieces of index information used before and after geomorphing of each polygon, and that outputs pieces of vertex information used before and after the geomorphing of the each polygon by using the pieces of index information; a vertex processor that performs a predetermined vertex-associated process on the pieces of vertex information of the each polygon; a polygon processor that interpolates vertex information between the pieces of vertex information, on which the vertex-associated process is performed, according to time, and outputs the vertex information for each polygon; a rasterizer that detects each pixel included in each polygon outputted by the polygon processor in an output image, and that outputs the pixel as pixel information which is interpolated between the pieces of vertex information of the polygon according to a position of the each pixel detected thereby; a pixel processor that determines a color of each pixel of a corresponding output image by using the pixel information outputted by the rasterizer; and an outputter that outputs the output image to an image display device.

### Advantages of the Invention

The geomorphing device in accordance with the present invention receives, as an input, vertex information in which pieces of information showing vertices used before and after geomorphing are recorded without redundancy and pieces of index information used before and after geomorphing of each polygon, and outputs pieces of vertex information used before and after the geomorphing of each polygon by using the pieces of index information. As a result, the geomorphing device can implement high-speed and memory-efficient geomorphing at a low cost.

### BRIEF DESCRIPTION OF THE FIGURES

FIG. 1 is an explanatory drawing showing an expression in which no indexes are used for polygon expression and an expression in which indexes are used for polygon expression;

FIG. 2 is an explanatory drawing showing an example of a model which is geomorphed at a time t ranging from 0 to 1;

FIG. 3 is an explanatory drawing showing a polygon drawing process flow in a typical GPU;

FIG. 4 is an explanatory drawing showing information about polygons which are used in order to implement conventional geomorphing;

FIG. 5 is a block diagram showing a geomorphing device in accordance with Embodiment 1 of the present invention;

FIG. 6 is an explanatory drawing showing information which is used in order to implement geomorphing in the geomorphing device in accordance with Embodiment 1 of the present invention;

FIG. 7 is an explanatory drawing showing output information in a case of inputting the information shown in FIG. 6 to an input assembling unit in the geomorphing device in accordance with Embodiment 1 of the present invention;

FIG. 8 is an explanatory drawing showing output information in a case of inputting information shown in FIG. 7 to a vertex processor in the geomorphing device in accordance with Embodiment 1 of the present invention;

FIG. 9 is an explanatory drawing showing output information in a case of inputting information shown in FIG. 8 to a polygon processing unit in the geomorphing device in accordance with Embodiment 1 of the present invention;

FIG. 10 is an explanatory drawing showing geomorphing in two stages in a geomorphing device in accordance with Embodiment 2 of the present invention; and

FIG. 11 is an explanatory drawing showing information which is used in order to implement geomorphing in the geomorphing device in accordance with Embodiment 2 of the present invention.

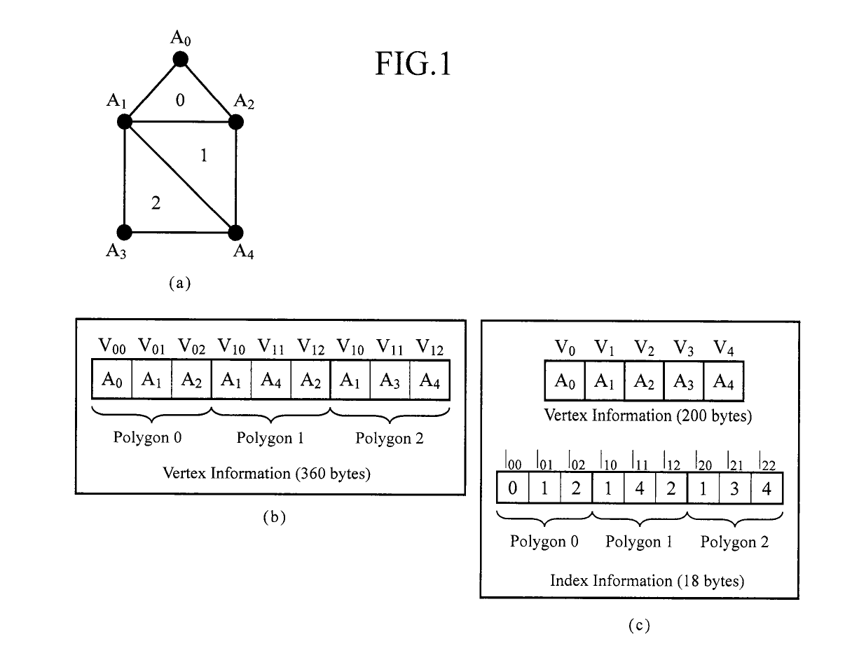

### EMBODIMENTS OF THE INVENTION

Hereafter, in order to explain this invention in greater detail, the preferred embodiments of the present invention will be described with reference to the accompanying drawings.

### Embodiment 1

FIG. 5 is a block diagram showing a geomorphing device in accordance with this embodiment. The geomorphing device shown in this figure includes an input assembling unit (input assembler) 1, a vertex processing unit (vertex processor) 2, a polygon processing unit (polygon processor) 3, a rasterizing unit (rasterizer) 4, a pixel processing unit (pixel processor) 5, an output unit (outputter) 6, a vertex memory 7, a texture memory 8, an output image memory 9, and an image display device 10.

The input assembling unit 1 collects and outputs pieces of vertex information before and after geomorphing for each polygon from vertex information and index information which are inputted thereto from the vertex memory 7. The vertex processor 2 performs predetermined processes independently applied to each vertex, such as projection conversion of vertex positions.

The polygon processing unit 3 generates and outputs vertex information which is interpolated between the pieces of vertex information before and after geomorphing according to a parameter showing a time. The rasterizing unit 4 detects pixels corresponding to the inside of each polygon on an output image, and outputs pixel information which is acquired by interpolating between pieces of vertex information according to the position of each of the pixels. The pixel processing unit 5 determines the color of each of the pixels from a pixel value in the texture memory 8 and the pixel information, and writes the color in the output image memory 9. The output unit 6 outputs the output image on the output image memory 9 to the image display device 10. Further, the vertex memory 7 stores vertex information and index information which are used by the geomorphing device, and the texture memory 8 stores a texture which is used by the geomorphing device. Further, the output image memory 9 stores the output image to be displayed on the image display device 10 as the geomorphing device.

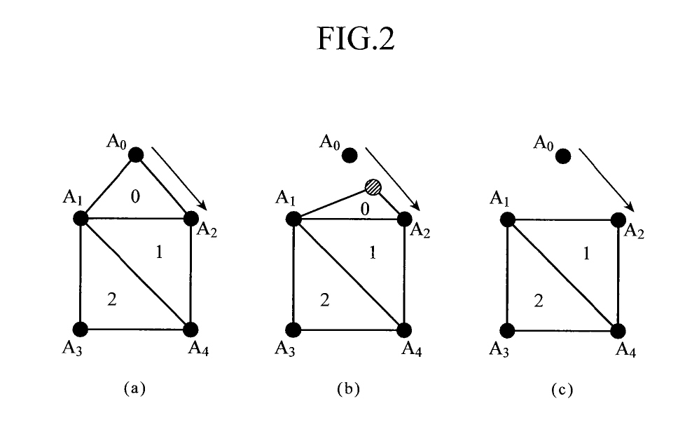

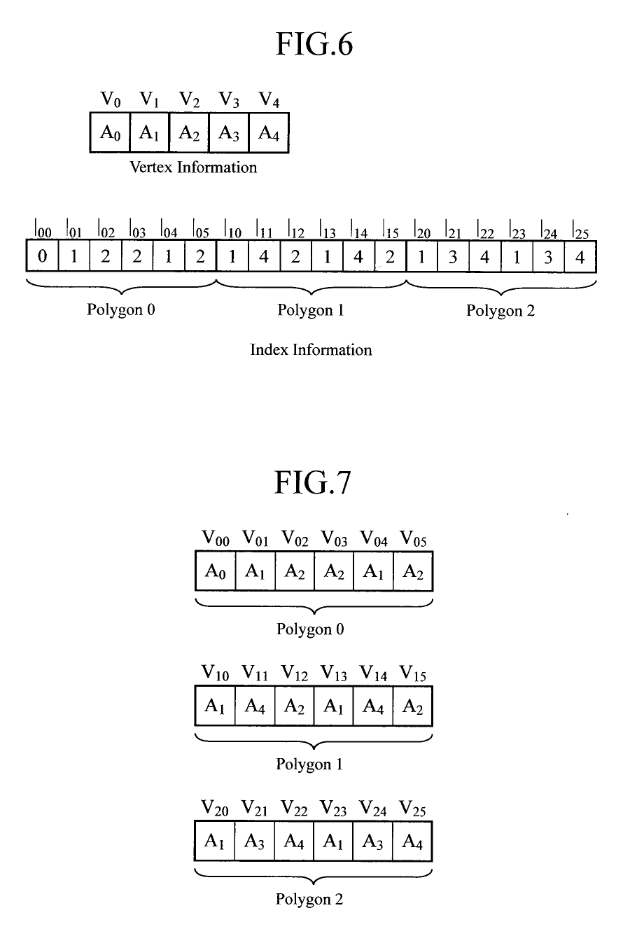

Next, the operation of the input assembling unit 1 will be explained by using FIGS. 6 and 7. The input assembling unit 1 receives the vertex information in which the positions of vertices, which construct a model before geomorphing, the positions of vertices, which construct a model after geomorphing, texture coordinates, and normals are recorded on a per vertex basis from the vertex memory 7. It is assumed that the vertex information is recorded without redundancy. Further, as to each polygon, the input assembling unit receives the index information in which six indexes including indexes respectively showing the three pieces of vertex information before geomorphing and indexes respectively showing the three pieces of vertex information after geomorphing are recorded from the vertex memory 7. FIG. 6 shows the vertex information and the index information which are used in order for the geomorphing device in accordance with the present invention to implement geomorphing as shown in FIG. 2. In the figure, Vₙ (n=0 to 4) shows each vertex information, and Aₙ (n=0 to 4) shows the value of Vₙ, i.e. , a set of values including the position, the texture coordinates, and the normal. Further, Iₖⱼ (k=0 to 2, j=0 to 2) is each of the indexes respectively showing the three pieces of vertex information before the geomorphing of a polygon k in FIG. 2, and Iₖⱼ (k=0 to 2, j=3 to 5) is each of the indexes respectively showing the three pieces of vertex information after the geomorphing of the polygon k.

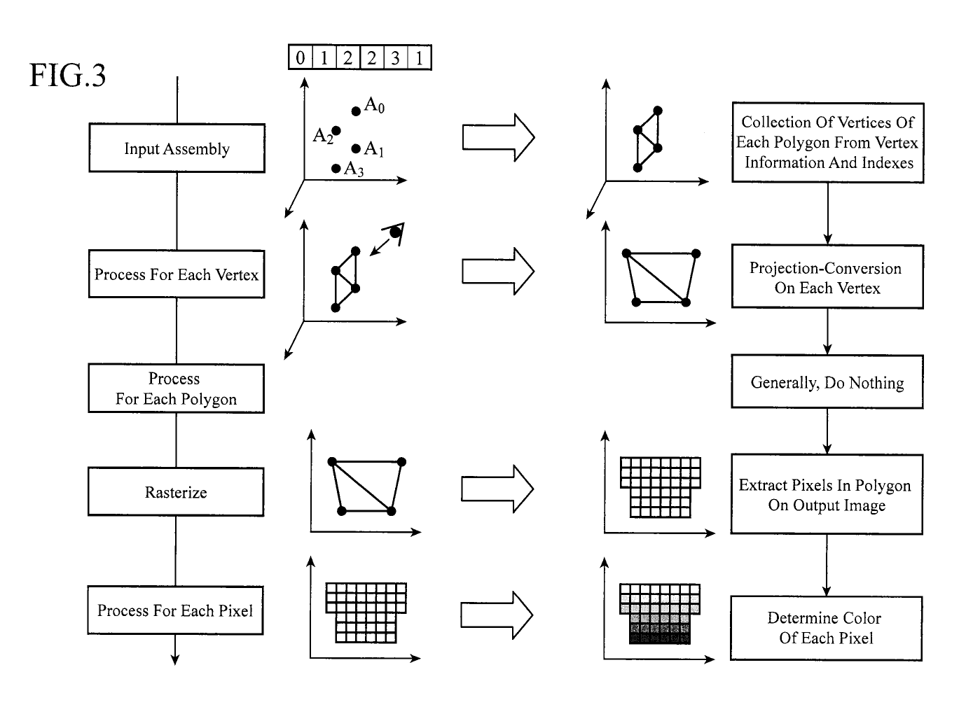

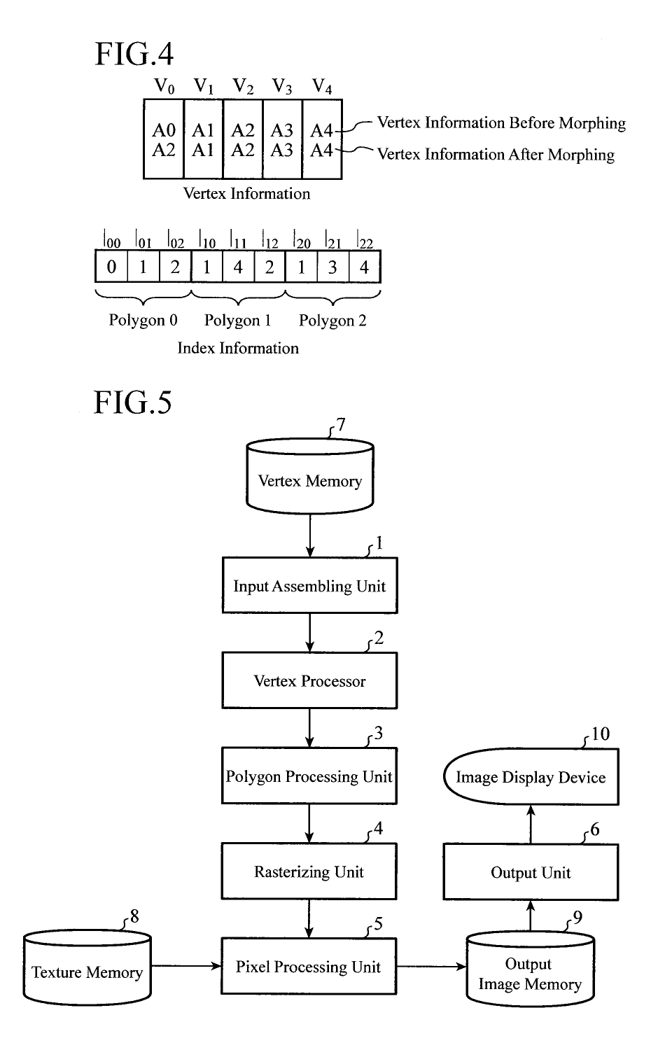

The input assembling unit 1 then refers to the pieces of vertex information pointed to by the six indexes for each polygon and collects the pieces of vertex information, and outputs each of the pieces of vertex information to the vertex processing unit 2. FIG. 7 shows the pieces of information outputted when the pieces of information shown in FIG. 6 are inputted. Although the operation of the input assembling unit 1 is the same as the input assembly described in the process flow by a typical GPU shown in FIG. 3, the input assembling unit collects the six pieces of vertex information, unlike in the case of a typical polygon drawing process of collecting three pieces of vertex information. A typical GPU can change the number of pieces of vertex information to be collected according to a parameter provided for the input assembly.

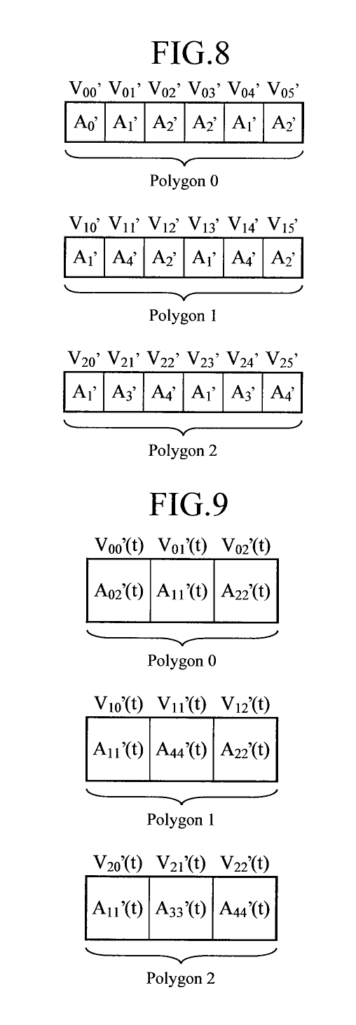

Next, the operation of the vertex processing unit 2 will be explained by using FIG. 8. The vertex processor 2 performs necessary processes on each vertex information outputted thereto from the input assembling unit 1 as needed. For example, when the polygon model is a three-dimensional one, the necessary processes include a process of carrying out projection conversion of the position coordinates to two-dimensional coordinates on the output image, and a process of transforming the normal in the case of using a light source. FIG. 8 shows information outputted when the pieces of information shown in FIG. 7 are inputted. In the figure, Aₙ′ (n=0 to 4) shows the result of applying the vertex processes including projection conversion to Aₙ. These processes can be easily carried out in parallel on a per vertex basis because the information is localized, i.e., the processes on each vertex do not refer to the vertex information about any other vertex. Further, the operation of the vertex processing unit 2 is the same as the process on each vertex which is described in the process flow by a typical GPU shown in FIG. 3.

The operation of the polygon processing unit 3 will be explained by using FIG. 9. The polygon processing unit 3 interpolates vertex information at a time t (0.0<=t<=1.0) between any two pieces of vertex information corresponding to before and after geomorphing, which are included in the six pieces of vertex information outputted from the processing unit 2, and outputs the vertex information at time t. Concretely, when receiving the vertex information Vₖⱼ (j=0 to 6) which the polygon k has, as to this polygon, the polygon processing unit outputs the following vertex information:

Vₖᵢ′(t)=Vₖᵢ′·(1−t)+Vₖᵢ₊₃′·t (i=0 to 2)

FIG. 9 shows the information outputted when the information shown in FIG. 8 is inputted. In the figure, Aₘₙ′(t) shows the value which is acquired at the time t by linear-interpolating between Aₘ′ and Aₙ′ (m, n=0 to 5).

The operation of the polygon processing unit 3 can be parallelized easily on a per polygon basis because the information is localized for each polygon, i.e., the processes on each polygon do not refer to the vertex information about any other polygon. Further, the processes by the polygon processing unit 3 can be implemented by programming, as a geometry shader, the processes on each polygon which are described in the process flow by a typical GPU shown in FIG. 3

The operation of the rasterizing unit 4 will be explained. The rasterizing unit 4 detects pixels, among the pixels on the output image, which are included in a region enclosed by the three vertices which construct each polygon outputted from the polygon processing unit 3. The rasterizing unit then carries out linear interpolation on the three pieces of vertex information to calculate vertex information at the position of each of the detected pixels, and outputs this vertex information as pixel information. A detailed explanation of the process by the rasterizing unit 4 will be omitted hereafter because the process corresponds to the rasterizing in the drawing flow by a typical GPU shown in FIG. 3 and is the same as the rasterizing.

The operation of the pixel processing unit 5 will be explained. The pixel processing unit 5 performs a necessary process on each pixel by using each pixel information outputted from the pixel processing unit 5 as needed. For example, this process is the one of calculating a color to be assigned to each pixel of the output image on the basis of the pixel information or the color information of the texture extracted from the texture memory 8, and writing the color into the output image stored in the output image memory 9. A detailed explanation of the process by the pixel processing unit 5 will be omitted hereafter because the process corresponds to the process on each pixel in the drawing flow by a typical GPU shown in FIG. 3 and is the same as the process.

The operation of the output unit 6 will be explained. After the pixel processing unit 5 completes all of the process, the output unit 6 outputs the output image stored in the output image memory 9 to the image display device 10.

Although the explanation is made by assuming that each polygon is a triangular one, each polygon can be any polygon such as a quadrangular polygon, and the input assembling unit 1 can collect twice as many pieces of vertex information as the number of angles of each polygon and, after that, carry out the same processes.

Thus, because the vertex information which is stored in the vertex memory 7 and which each polygon before and after morphing has is recorded without redundancy and each polygon is expressed in a form in which it is specified by indexes in Embodiment 1, the geomorphing process can be carried out with a small amount of recorded data. Further, because the information is localized for each polygon in the polygon processing unit 3 that performs the interpolation process for geomorphing, the interpolation process can be easily sped up through parallelization. In addition, because each of the processing units operates according to a process flow in a typical GPU, each of the processing units can be made to operate on the GPU and can be implemented at a low cost.

As previously explained, because the geomorphing device in accordance with Embodiment 1 includes: the input assembler that receives, as an input, vertex information in which pieces of information showing vertices used before and after geomorphing are recorded without redundancy and pieces of index information used before and after geomorphing of each polygon, and that outputs pieces of vertex information used before and after the geomorphing of each polygon by using the pieces of index information; the vertex processor that performs a predetermined vertex-associated process on the pieces of vertex information of each polygon; the polygon processor that interpolates vertex information between the pieces of vertex information, on which the vertex-associated process is performed, according to time, and outputs the vertex information for each polygon; the rasterizer that detects each pixel included in each polygon outputted by the polygon processor in an output image, and that outputs each pixel as pixel information which is interpolated between the pieces of vertex information of the polygon according to the position of each pixel detected thereby; the pixel processor that determines the color of each pixel of a corresponding output image by using the pixel information outputted by the rasterizer; and the outputter that outputs the output image to the image display device, the geomorphing device can implement high-speed and memory-efficient geomorphing at a low cost.

Further, because in the geomorphing device in accordance with Embodiment 1 the input assembler collects pieces of vertex information twice as many as the number of vertices of each polygon and outputs the pieces of vertex information to the vertex processor, the geomorphing device can implement high-speed and memory-efficient geomorphing at a low cost.

In addition, because in the geomorphing device in accordance with Embodiment 1 the vertex processor carries out the process on each inputted vertex information in parallel on a per vertex basis, the geomorphing device can implement high-speed and memory-efficient geomorphing at a low cost.

Further, because in the geomorphing device in accordance with Embodiment 1 the polygon processor linear-interpolates vertex information between the pieces of vertex information before and after the geomorphing of each vertex which constructs a polygon according to time and outputs the vertex information, the geomorphing device can implement high-speed and memory-efficient geomorphing at a low cost.

In addition, because in the geomorphing device in accordance with Embodiment 1 the polygon processor carries out the interpolation process on each inputted vertex information in parallel on a per polygon basis, the geomorphing device can implement high-speed and memory-efficient geomorphing at a low cost.

### Embodiment 2

The geomorphing device in accordance with Embodiment 1 geomorphs a polygon model to a different polygon model. In accordance with the present invention, when geomorphing a polygon model in a plurality of stages, the geomorphing can be carried out while information is held more efficiently. In Embodiment 2, an example of changing a polygon model to a different polygon model by using geomorphing in a first stage, and further changing the model after the geomorphing in the first stage by using geomorphing in a second stage is shown.

Because a geomorphing device in accordance with Embodiment 2 has the same structure as that in accordance with Embodiment 1 in terms of drawings, the structure will be explained by using FIG. 5. An input assembling unit 1 in accordance with Embodiment 2 receives, as an input, vertex information which is shared before and after geomorphing in a plurality of stages from a vertex memory 7 and index information used before and after geomorphing of each polygon in a plurality of stages, and outputs vertex information used before and after the geomorphing of each polygon in the plurality of stages by using the index information. A vertex processing unit 2 performs a predetermined vertex-associated process on the pieces of vertex information in the plurality of stages of each polygon which is outputted from the input assembling unit 1. Because a polygon processing unit 3 to an image display device 10, other than the input assembling unit and the vertex processing unit, are the same as those in accordance with Embodiment 1, the explanation of the components will be omitted hereafter.

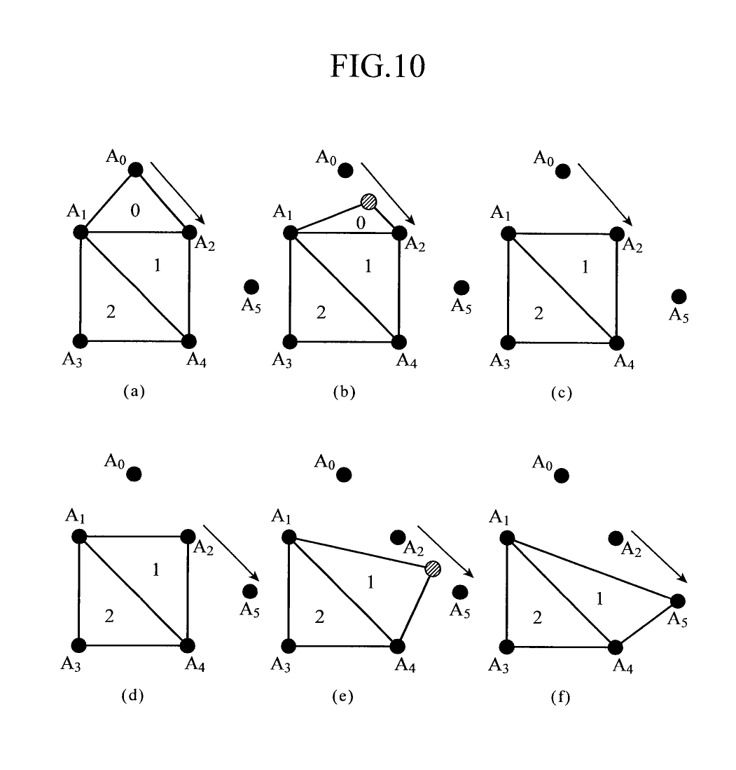

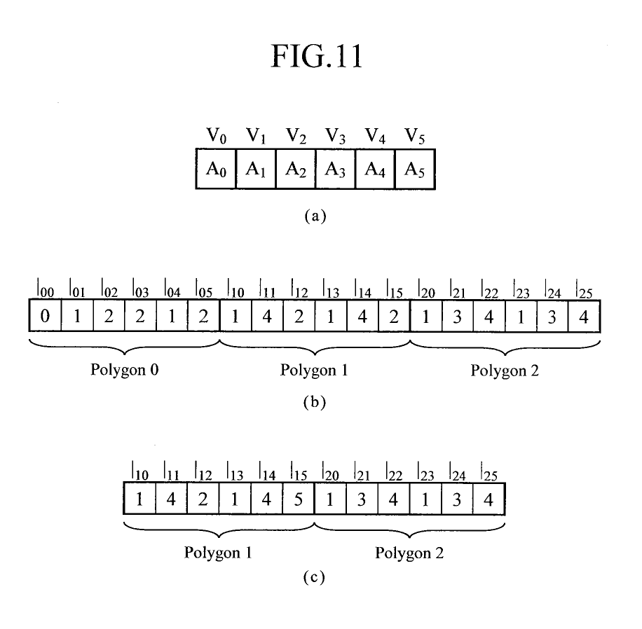

Next, the operation of the geomorphing device in accordance with Embodiment 2 will be explained by using FIGS. 10 and 11. FIG. 10 shows an example of the geomorphing in two stages. FIGS. 10(a) and 10(c) show polygon models (referred to as polygon models 0 and 1) before and after the geomorphing in the first stage, and FIG. 10(b) shows a polygon model which is generated during the geomorphing in the first stage. Further, FIGS. 10(d) and 10(f) show polygon models (referred to as polygon models 2 and 3) before and after the geomorphing in the second stage, and FIG. 10(e) shows a polygon model which is generated during the geomorphing in the second stage.

FIG. 11 shows information used in order to implement the geomorphing in two stages shown in FIG. 10. In the figure, (a) shows vertex information which is shared, (b) shows index information which is used for the geomorphing in the first stage, and (c) shows index information which is used for the geomorphing in the second stage. In FIG. 11(a), Vₙ (n=0 to 5) shows each of pieces of vertex information of the polygon models 0 to 3 which are recorded without redundancy. Further, in FIG. 11(b), Iₖⱼ (k=0 to 2, j=0 to 2) shows each of indexes respectively showing the three pieces of vertex information about the three vertices which construct a polygon k of the polygon model 0, and Iₖⱼ (k=0 to 2, j=3 to 5) shows each of indexes respectively showing the three pieces of vertex information about the three vertices which construct a polygon k of the polygon model 1. Similarly, Iₖⱼ (k=1 to 2, j=0 to 5) in FIG. 11(c) shows each of indexes respectively showing the three vertices which construct a polygon k of the polygon models 2 and 3.

In accordance with Embodiment 2, by inputting the vertex information and the index information which are shown in FIGS. 11(a) and 11(b) to the input assembling unit 1 and carrying out the same processes as those shown in Embodiment 1, the geomorphing in the first stage shown in FIG. 10 can be implemented. By then inputting the vertex information and the index information which are shown in FIGS. 11(a) and 11(c) to the input assembling unit 1, and carrying out the same processes as those shown in Embodiment 1, the geomorphing in the second stage shown in FIG. 10 can be implemented. In this case, although the polygon models 1 and 2 consist of different pieces of index information, the second morphing can be carried out smoothly after the first morphing because the results of drawing the polygon models are the same as each other.

Although two stages of geomorphing is explained in Embodiment 2, even when carrying out geomorphing in an arbitrary number of stages, by preparing both pieces of vertex information which are used in all the stages and which are recorded without redundancy, and index information used for each of the stages, geomorphing in each of the stages can be carried out similarly.

Thus, because the geomorphing device in accordance with Embodiment 2 of the present invention includes the input assembler that receives, as an input, vertex information which is shared before and after geomorphing in a plurality of stages and index information used before and after geomorphing of each polygon in a plurality of stages, and that outputs pieces of vertex information used before and after the geomorphing of each polygon in the plurality of stages by using the above-mentioned index information; the vertex processor that performs a predetermined vertex-associated process on the pieces of vertex information of each polygon in the plurality of stages; the polygon processor that interpolates vertex information between the pieces of vertex information, on which the vertex-associated process is performed, according to time, and outputs the vertex information for each polygon; the rasterizer that detects each pixel included in each polygon outputted by the polygon processor in an output image, and that outputs the pixel as pixel information which is interpolated between the pieces of vertex information of the polygon according to the position of each pixel detected thereby; the pixel processor that determines the color of each pixel of a corresponding output image by using the pixel information outputted by the rasterizer; and the outputter that outputs the output image to the image display device, when carrying out geomorphing in a plurality of phases, the geomorphing device can record the vertex information before and after every geomorphing without redundancy, and use the vertex information. Therefore, the geomorphing device can reduce the amount of memory in which vertex information is recorded.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

As mentioned above, the geomorphing device in accordance with the present invention relates to a structure of carrying out a geomorphing process of smoothly replacing a polygon model with a different polygon model by gradually changing each vertex information of the polygon model, the geomorphing device is suitable for use in an image processing device or the like that processes a polygon mode in computer graphics.

### EXPLANATIONS OF REFERENCE NUMERALS

1 input assembling unit, 2 vertex processing unit, 3 polygon processing unit, 4 rasterizing unit, 5 pixel processing unit, 6 output unit, 7 vertex memory, 8 texture memory, 9 output image memory, 10 image display device.

1. A geomorphing device comprising:
an input assembler that receives, as an input, vertex information in which pieces of information showing vertices used before and after geomorphing are recorded without redundancy and pieces of index information used before and after geomorphing of each polygon, and that outputs pieces of vertex information used before and after the geomorphing of said each polygon by using said pieces of index information;
a vertex processor that performs a predetermined vertex-associated process on the pieces of vertex information of said each polygon;
a polygon processor that interpolates vertex information between the pieces of vertex information, on which said vertex-associated process is performed, according to time, and outputs the vertex information for each polygon;
a rasterizer that detects each pixel included in each polygon outputted by said polygon processor in an output image, and that outputs the pixel as pixel information which is interpolated between the pieces of vertex information of the polygon according to a position of said each pixel detected thereby;
a pixel processor that determines a color of each pixel of a corresponding output image by using the pixel information outputted by said rasterizer; and
an outputter that outputs said output image to an image display device.

2. The geomorphing device according to claim 1, wherein the input assembler collects the pieces of vertex information whose number is twice as many as a number of vertices of each polygon and outputs the pieces of vertex information to the vertex processor.

3. The geomorphing device according to claim 1, wherein the vertex processor performs the process on each piece of inputted vertex information in parallel on a per vertex basis.

4. The geomorphing device according to claim 1, wherein the polygon processor linear-interpolates vertex information between the pieces of vertex information before and after the geomorphing of each vertex which constructs each polygon according to a time, and outputs the vertex information.

5. The geomorphing device according to claim 1, wherein the polygon processor performs the interpolation process on each piece of inputted vertex information in parallel on a per polygon basis.

6. A geomorphing device comprising:
an input assembler that receives, as an input, pieces of vertex information which is shared before and after geomorphing in a plurality of stages and pieces of index information used before and after geomorphing of each polygon in a plurality of stages, and that outputs pieces of vertex information used before and after the geomorphing of said each polygon in the plurality of stages by using said index information;
a vertex processor that performs a predetermined vertex-associated process on the pieces of vertex information of said each polygon in the plurality of stages;
a polygon processor that interpolates vertex information between the pieces of vertex information, on which said vertex-associated process is performed, according to time, and outputs the vertex information for each polygon;
a rasterizer that detects each pixel included in each polygon outputted by said polygon processor in an output image, and that outputs the pixel as pixel information which is interpolated between the pieces of vertex information of the polygon according to a position of said each pixel detected thereby;
a pixel processor that determines a color of each pixel of a corresponding output image by using the pixel information outputted by said rasterizer; and
an outputter that outputs said output image to an image display device.
